(19) United States
(12) Patent Application Publication
(10) Pub. No.: US 2008/0166177 A1
(43) Pub. Date: Jul. 10, 2008

(54) Marker with replaceable nib

(76) Inventor: Saleh J. Alghabban, Riyadh (SA)

Correspondence Address: SETO PATENTS, 406 RIVERLAND DR., SALEM, VA, 24153, US

(21) Appl. No.: 11/651,369

(22) Filed: Jan. 9, 2007

(51) Int. Cl. B43K 8/06

(52) U.S. Cl. 401/198

(57) ABSTRACT

A marker with a replaceable nib. Refillable markers are well-known however, after the marker's tip, or nib, wears out the marker must be thrown away. The present invention solves this problem by providing nibs that can be replaced after being worn out. The replaceable nib includes a casing that at least partially surrounds the nib and allows for easy handling of the nib. The nib slides into an opening in the front of a marker body. The nib and marker body include complementary portions of a locking mechanism that allows the nib to be snap-locked into place when fully inserted. Nibs can be provided with different shaped tips to suit the needs of the user, and the marker body can include a nib spring that helps eject, or remove, old nibs from the body.

### BACKGROUND OF THE INVENTION

The present invention relates generally to the field of writing devices and more specifically to a writing device with a replaceable nib.

A traditional marker consists of a marker body that holds a reservoir of ink and a nib that extends out of the top of the marker body and through which the ink in the marker is distributed in a controlled manner. When the marker runs out of ink, it is possible to refill the reservoir with more ink. Traditional markers include a plug at the bottom of the marker's body that can be removed to allow addition of more ink. The nib at the top of a traditional marker however, is not replaceable. After many uses, the nib of a traditional marker becomes deformed, or clogged, and the nib is no longer able to operate in its intended manner. When the nib is no longer able to secrete ink from the marker body, the entire marker is thrown away, even though the marker body may still contain a good supply of ink. When this happens, it is wasteful, results in more markers filling landfills than is necessary, and therefore is not environmentally friendly.

What is needed in the field is a marker that not only includes a refillable ink reservoir but also includes a replaceable nib. The ideal marker would include multiple nib cartridges with different shaped nibs so that fine, broad and consistent marking can be provided. The ideal marker would also include an easy to use locking mechanism that allows each nib cartridge to be temporarily locked in place within the marker body.

### SUMMARY OF THE INVENTION

A replaceable nib that is adapted for insertion into, and removal from, a marker body, so that when an old nib wears out, the old nib can be removed and replaced with a new nib. The marker body includes an opening in the front of the body that is able to accept the replaceable nib. The replaceable nib comprises an ink conductor and a case. The ink conductor has a tip at one end for transferring ink from the nib to a writing surface, and a connecting end at the opposite end that makes contact with the ink supply in the marker body, when the nib is fully inserted in the marker body. The nib's case surrounds the middle portion of the ink conductor, aids in supporting the ends of the ink conductor, and provides for easy handling of the replaceable nib.

The replaceable nib preferably includes part of a locking mechanism that aids in temporarily locking the replaceable nib in place when the nib is fully inserted into the opening in the marker body. In the preferred embodiment, the locking mechanism on the nib includes a spring loaded latch that is biased in the protruding position. The nib case also preferably has a cylindrical shape and the tip of the ink conductor has a chisel shape. However, the tip of the nib can also take other shapes in other embodiments.

In an alternative embodiment, a long lasting, refillable writing device is provided with a replaceable writing tip. The refillable writing device comprises a replaceable nib and a device body. The replaceable nib comprises an ink conductor and a case. The ink conductor has a tip at one end for transferring ink from the nib to a writing surface, and a connecting end at the opposite end. The case surrounds the middle of the ink conductor, and provides for easy handling of the replaceable nib. The device body comprises a housing, a nib opening and a refillable ink supply. The body housing substantially defines the shape of the writing device and the shape of the device allows for easy grasping by the user. The nib opening is in the front of the housing and allows for insertion, and removal, of the replaceable nib. The refillable ink supply is stored in the interior of the device body. The connecting end of the ink conductor makes contact with the ink supply when the nib is fully inserted in the device body.

The replaceable nib preferably includes the male portion of a locking mechanism that allows the nib to be temporarily locked in place within the housing. The housing of the device body preferably includes the female portion of the locking mechanism. The male portion of the locking mechanism is preferably a spring loaded latch that is biased in the open, or protruding, position. The female portion of the locking mechanism is preferably an opening in the marker housing that allows protrusion therethrough of the biased latch on the nib.

In another alternative embodiment, the bottom of the nib opening in the housing includes spring that is compressed when the nib is inserted in the opening, and upon release of the locking mechanism, decompression of the spring assists in removal of the nib.

It is an object of the present invention to extend the life of a traditional writing device by providing a nib that can be used to replace an old and worn out nib.

It is another object of the present invention to provide a long lasting writing device that is adapted for insertion, and removal, of a replaceable nib.

It is still another object of the present invention to provide a replaceable nib that can be temporarily locked in place within a marker body and that can refill the marker body with ink.

It is yet another object of the present invention to provide a writing device with a spring loaded replaceable nib that assists in removal of an old nib.

### BRIEF DESCRIPTION OF THE DRAWINGS

The invention of the present application will now be described in more detail with reference to the accompanying drawings, given only by way of example, in which:

FIG. 1(a) shows the preferred embodiment of the present replaceable nib;

FIG. 1(b) shows an alternative embodiment of the present replaceable nib;

FIG. 2 shows the preferred nib fully inserted in an exemplary marker body;

FIG. 3 shows the preferred nib fully inserted in another exemplary marker body;

FIG. 4 shows the preferred nib fully inserted in the preferred embodiment of the marker body; and,

FIG. 5 shows an alternative embodiment of the present marker with replaceable nib.

### DETAILED DESCRIPTION OF THE INVENTION

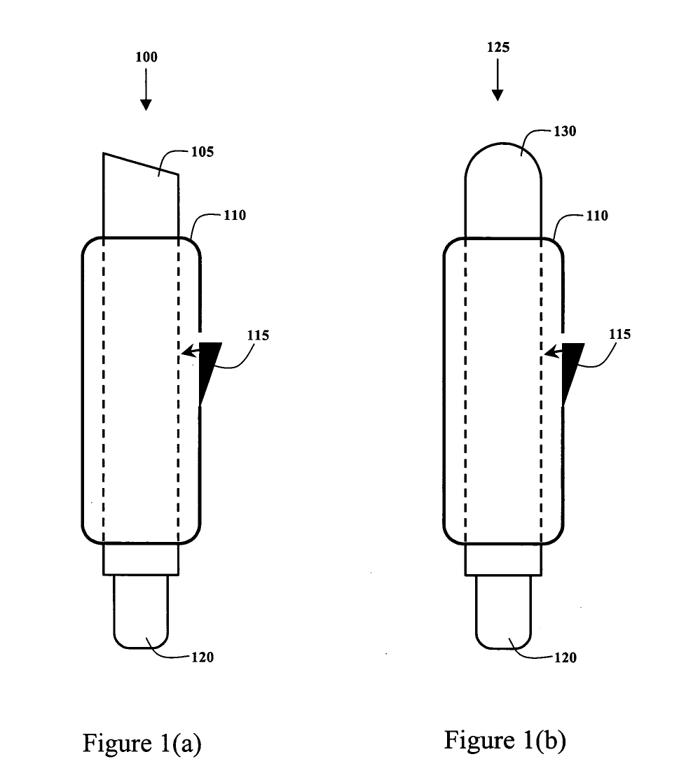

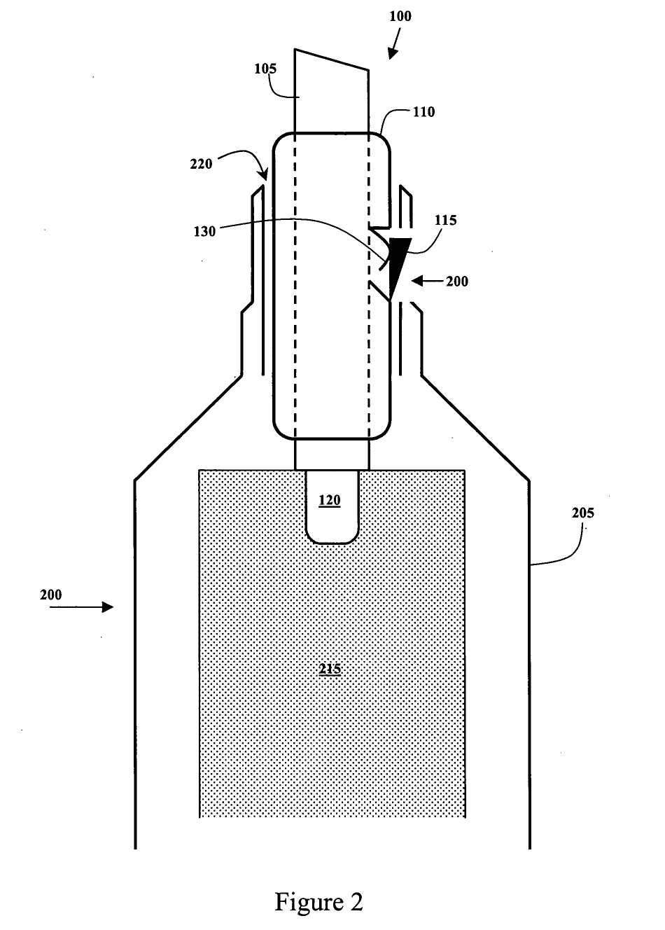

FIG. 1 shows the preferred embodiment of the present replaceable nib 100, which together with a refillable marker body will provide a pen that, in theory, could last forever. Making pens and markers that could be refilled with ink was a great advancement in writing devices. However, in the case of markers, the writing device while having an endless supply of ink, still only lasted as long as the nib, or writing tip, was in good and usable condition. Once the nib was worn out, even refillable markers were useless and had to be thrown away. The present replaceable nib 100 provides the perfect complement to a marker with an endless supply of ink, by providing an endless supply of nibs. The preferred embodiment of the replaceable nib 100 includes a chisel shaped tip 105 that allows the user to draw fine and broad lines. The nib 100 also includes a case 110 that houses the tip 105 and allows for easy handling of the nib. A moveable latch 115 is provided on the exterior of the case 110 to lock the nib 100 in place, when inserted in a marker body (shown in FIG. 2). The latch 115 is biased in the open position, shown in FIG. 1(a), and the latch can be moved inward, toward the center of the nib 100, by simply pressing on the latch. The bottom of the nib 100 includes a connecting end 120 that connects to the ink supply in the marker body. The connecting end 120 allows ink in the marker body to flow into the nib 100 and up to the tip 105.

FIG. 1(b) shows an alternative embodiment of a replaceable nib 125 with a bullet shaped tip 130. The bullet shaped tip 130 of this nib 125 allows the user to draw with a consistent line thickness, no matter how the marker is held. The other parts of the alternative nib 125 are the same as those on the preferred nib 100. A case 110 is used to house the tip 130. A moveable latch 115 can be provided to secure the nib 125 within a marker body. And, the bottom of the nib 125 includes a connecting end 120 that allows ink to flow to the tip 130 of the nib.

FIG. 2 shows the preferred nib 100 fully inserted in an exemplary marker body 200. The marker body 200 includes a housing 205 that substantially defines the shape of the marker and an ink supply 215 that is held within the interior of the marker body. The top of the housing 205 includes a nib opening 220 that is complementary in size to the replaceable nib 100. The nib opening 220 allows nibs to be inserted into, and removed from, the marker body 200. The marker body's housing 205 also includes a latch opening 210 that allows the nib's latch 115 to fully extend and thereby lock the nib 100 in place within the marker body 200. The latch 115, which is biased open by a latch spring 130, is compressed inward when the nib 100 is initially inserted in the nib opening 220. After the nib 100 is fully inserted into the marker body 200, the latch 115 springs open, through latch opening 210, and the present everlasting marker is ready to use. When the nib 100 is fully inserted, the connecting end 120 of the nib makes contact with the ink supply 215 in the marker body 200 and the supply of ink is made available to the tip 105 of the nib. When the user is ready to replace the nib 100, he presses the latch 115 inward and pulls on the top of the nib case 110 to pull the nib from the marker body 200.

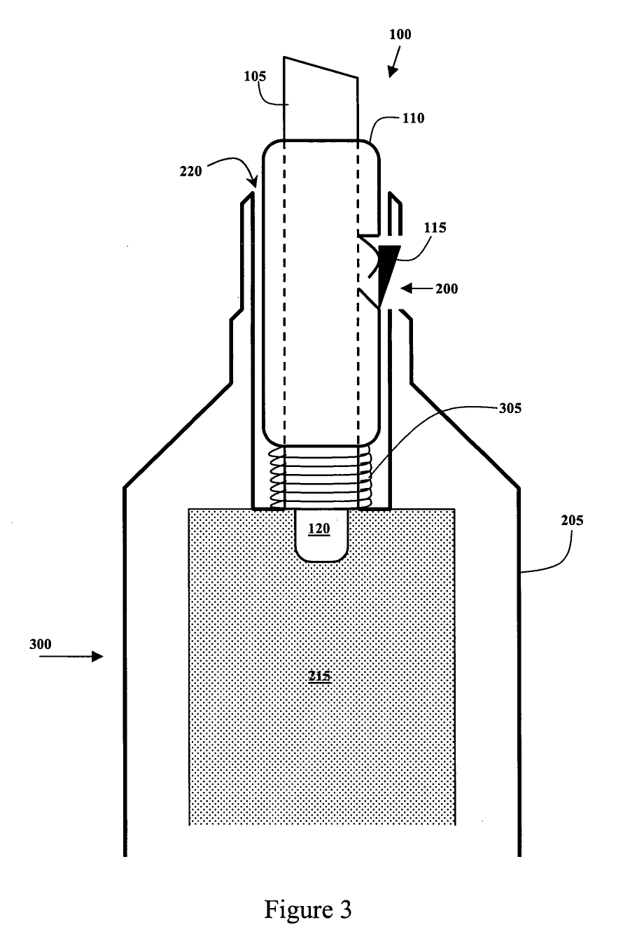

FIG. 3 shows the preferred replaceable nib 100 fully inserted inside another exemplary marker body 300. In this embodiment, a nib spring 305 is provided at the bottom of the nib opening 220 in the housing 205 to assist in replacement of nibs. When the user is ready to replace the nib 100, he presses on the latch 115 and the nib spring 305 forces the nib 100 upward so that at least half of the length of the nib 100 is exposed for the user to grasp. The nib spring 305 is intended to allow the user to replace nibs in a neat and stain free manner, i.e., without getting any ink stains on his fingers.

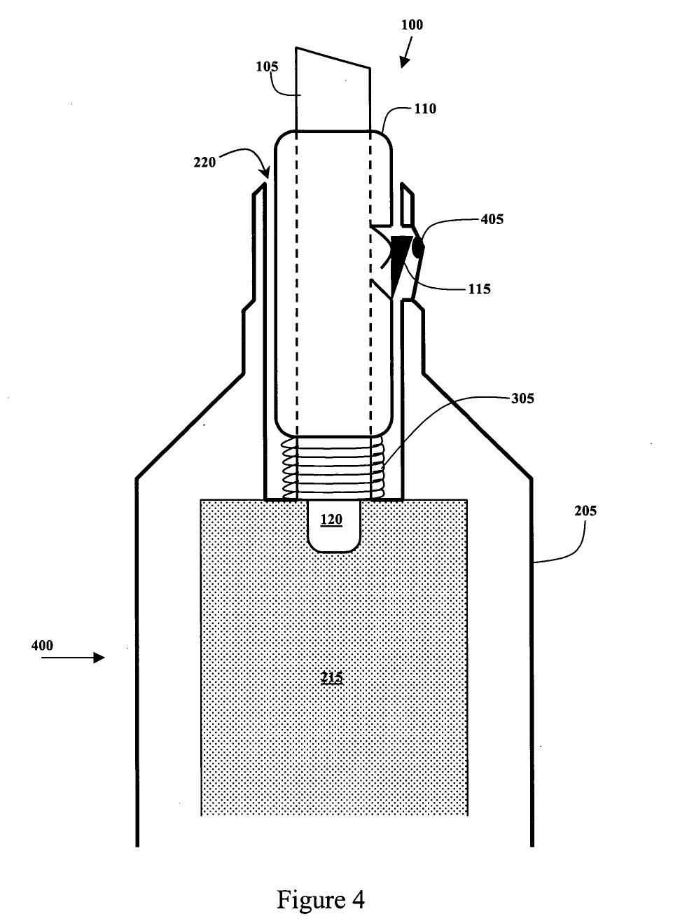

FIG. 4 shows the preferred replaceable nib 100 fully inserted in the preferred embodiment of the marker body 400. The preferred marker body 400 includes a nib spring 305 to assist users in replacing nibs, and also includes a flexible latch cover 405 that prevents any pinching of finger tips from occurring, between the latch 115 and the latch opening in the housing 205. The latch cover 405 is preferably made of a semi-flexible yet durable material that covers the latch opening but allows the latch 115 to fully extend to the open position, shown in FIG. 4. The latch cover 405 must also be able to flex inward enough to allow the latch 115 to be compressed for removal of the nib 100 from the marker body 400. The ink supply 215 in the marker body 400, and in all of the present marker bodies, can be refilled through the nib opening 220 when the nib is removed. The ink supplies can also be refilled through the bottom of the maker body using well-known, traditional methods discussed above.

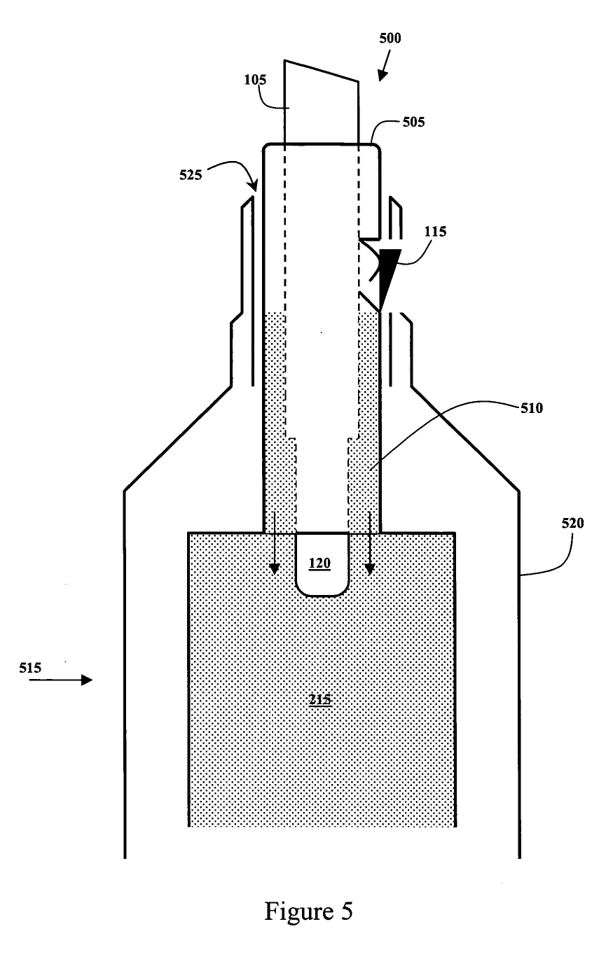

FIG. 5 shows a marker body 515 with an ink supply 215 that can be refilled by an embodiment of the replaceable nib 500. In this embodiment, the lower portion of the case 505 of the nib 500 includes an amount of refill ink 510. After the nib 500 is fully inserted in the marker body 515, the refill ink 510 is allowed to flow into the body's ink supply 215. At least one needle is preferably provided at the bottom of the opening 525 in the housing 520 to assist in the transfer of ink. The refill ink 500 is advantageously deposited at the top of the marker body's ink supply 215, next to the bottom of the nib 500, thereby maximizing ink flow into the nib 500.

The foregoing description of the specific embodiments will so fully reveal the general nature of the invention that others can, by applying current knowledge, readily modify and/or adapt for various applications such specific embodiments without departing from the generic concept. For example, a replaceable nib could be provided without a latch that is simply held in place by friction. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A replaceable nib that is adapted for insertion into, and removal from, a marker body, so that when an old nib wears out, the old nib can be removed and replaced with a new nib, wherein the marker body includes an opening in a front of the body that is able to accept the replaceable nib, the replaceable nib comprising:
an ink conductor, the ink conductor having a tip at one end for transferring ink from the nib to a writing surface, and a connecting end at an opposite end that makes contact with an ink supply in the marker body when the nib is fully inserted into the marker body; and,
a case that surrounds a middle portion of the ink conductor, aids in supporting the ink conductor, and provides for easy handling of the replaceable nib.

2. The replaceable nib of claim 1, wherein the nib further comprises:
at least part of a locking mechanism that aids in temporarily locking the replaceable nib in place when the nib is fully inserted into the opening in the marker body.

3. The replaceable nib of claim 2, wherein the part of the locking mechanism on the nib is a spring loaded latch that is biased in the open position.

4. The replaceable nib of claim 1, wherein the case has a generally cylindrical shape and the tip of the ink conductor has a chisel shape.

5. The replaceable nib of claim 1, wherein the case has a generally cylindrical shape and the tip of the ink conductor has a rounded, bullet shape.

6. A refillable writing device with a replaceable writing tip that provides an efficient, reusable device for drawing and writing, the refillable writing device comprising:
a replaceable nib, the nib comprising:
an ink conductor, the ink conductor having a tip at one end for transferring ink from the nib to a writing surface, and a connecting end at an opposite end of the ink conductor; and,
a case that a surrounds a middle portion of the ink conductor, aids in supporting both ends of the ink conductor, and provides for easy handling of the replaceable nib; and,
a device body, the body comprising:
a housing that substantially defines a shape of the writing device, wherein the shape of the device allows for easy grasping by a user;
a nib opening in a front of the housing that allows for insertion, and removal, of the replaceable nib; and,
a refillable ink supply that is stored in an interior of the device body, wherein the connecting end of the ink conductor contacts the ink supply when the nib is fully inserted in the device body.

7. The writing device of claim 6, wherein the case of the replaceable nib includes a male portion of a locking mechanism that allows the nib to be temporarily locked in place when fully inserted in the nib opening of the housing.

8. The writing device of claim 7, wherein the housing of the device body includes a female portion of the locking mechanism that allows the nib to be temporarily locked in place when fully inserted in the nib opening of the housing.

9. The writing device of claim 7, wherein the male portion of the locking mechanism is a spring loaded latch that is biased in the open position.

10. The writing device of claim 8, wherein the female portion of the locking mechanism is a latch opening that allows protrusion therethrough of the male portion of the locking mechanism.

11. The writing device of claim 8, wherein the nib opening in the housing includes a bottom, and a nib spring is provided at the bottom of the nib opening, wherein the spring is at least partially compressed when the nib is fully inserted in the opening and upon depression of the locking mechanism, the spring assists in removal of the nib from the housing.

12. The writing device of claim 6, wherein the case has a generally cylindrical shape and the tip of the ink conductor has a chisel shape that allows for both broad and fine lines.

13. The writing device of claim 6, wherein the case has a generally cylindrical shape and the tip of the ink conductor has a rounded, bullet shape that allows for a consistent line thickness no matter how the writing device is grasped by the user.

14. The writing device of claim 10, wherein the device body further comprises a cover for the latch opening, the cover being made of a semi-flexible material that allows the male portion of the locking mechanism to protrude through the latch opening and also allows a user to push the male portion back through the latch opening when the user is ready to replace the nib.

15. The writing device of claim 6, wherein a lower portion of the nib's case houses an amount of refilling ink, and a bottom on the nib opening includes a refilling protrusion that is capable of piercing the lower portion of the case when the nib is fully inserted in the device body and thereby allowing the amount of refilling ink to flow into the refillable ink supply.

16. The writing device of claim 6, wherein the ink conductor is primarily made of a fibrous material, including felt.
